(19) United States
(12) Patent Application Publication
(10) Pub. No.: US 2012/0274551 A1
(43) Pub. Date: Nov. 1, 2012

(54) ELECTRONIC DEVICE, SCREEN CONTROL METHOD, AND STORAGE MEDIUM STORING SCREEN CONTROL PROGRAM

(75) Inventors: Yuka ISHIZUKA, Yokohama-shi (JP); Tsuneo MIYASHITA, Yokohama-shi (JP)

(73) Assignee: KYOCERA CORPORATION, Kyoto (JP)

(21) Appl. No.: 13/455,403

(22) Filed: Apr. 25, 2012

(30) Foreign Application Priority Data
Apr. 26, 2011 (JP) 2011-098489

(51) Int. Cl. G09G 5/00

(52) U.S. Cl. 345/156

(57) ABSTRACT

According to an aspect, an electronic device includes a first display unit, a second display unit, a detecting unit, and a control unit. The first display unit displays a first object corresponding to a first function. The second display unit displays a second object corresponding to a second function. The detecting unit detects an operation. When the operation is detected by the detecting unit while the first object is displayed on the first display unit, the control unit dismisses the first object from the first display unit and displays information with respect to the first object on the second display unit.

### CROSS-REFERENCE TO RELATED APPLICATIONS

This application claims priority from Japanese Application No. 2011-098489, filed on Apr. 26, 2011, the content of which is incorporated by reference herein in its entirety.

### BACKGROUND

1. Technical Field

The present disclosure relates to an electronic device, a screen control method, and a storage medium storing therein a screen control program.

2. Description of the Related Art

Some electronic devices such as mobile phones can create a shortcut in order to simply activate a frequently used function. For example, there is a known technology of displaying a shortcut item (object) associated with a specific application program, on a standby screen of a mobile phone (see, for example, Japanese Patent Application Laid-Open No. 2007-317223).

With the use of this technology, a desired application program can be rapidly activated even without performing a complicated operation, such as activating a desired application program by exploring a menu hierarchy on a standby screen.

Some electronic devices display a created shortcut object as an icon. When an object is displayed as an icon, the object can be efficiently displayed in a small space. These electronic devices are configured to display the details of the object when detecting an operation, such as an operation of changing a display setting of the object and an operation of holding a cursor over the object for a predetermined period of time. However, these operations are difficult to perform intuitively.

For the foregoing reasons, there is a need for an electronic device, a screen control method, and a screen control program that allow the user to recognize the details of object by a simple operation.

### SUMMARY

According to an aspect, an electronic device includes a first display unit, a second display unit, a detecting unit, and a control unit. The first display unit displays a first object corresponding to a first function. The second display unit displays a second object corresponding to a second function. The detecting unit detects an operation. When the operation is detected by the detecting unit while the first object is displayed on the first display unit, the control unit dismisses the first object from the first display unit and displays information with respect to the first object on the second display unit.

According to another aspect, a screen control method is executed by an electronic device including a first display unit, a second display unit, and a detecting unit. The screen control method includes: displaying an object corresponding to a function on the first display unit; detecting an operation by the detecting unit while the object is displayed on the first display unit; and dismissing the first object from the first display unit and displaying information with respect to the first object on the second display, upon detection of the operation.

According to another aspect, a non-transitory storage medium stores therein a screen control program. When executed by an electronic device including a first display unit, a second display unit, and a detecting unit, the screen control program causes the electronic device to execute: displaying an object corresponding to a function on the first display unit; detecting an operation by the detecting unit while the object is displayed on the first display unit; and dismissing the first object from the first display unit and displaying information with respect to the first object on the second display, upon detection of the operation.

### BRIEF DESCRIPTION OF THE DRAWINGS

FIG. 1 is a perspective view of a mobile phone in a first form;

FIG. 2 is a perspective view of the mobile phone in a second form;

FIG. 3 is a diagram illustrating an example of a screen displayed on a first display unit;

FIG. 4 is a diagram illustrating an example of screens displayed on the first display unit and a second display unit;

FIG. 5 is a diagram illustrating an example of screens displayed on the first display unit and the second display unit;

FIG. 6 is a diagram illustrating an example of screens displayed on the first display unit and the second display unit;

FIG. 7 is a block diagram of the mobile phone;

FIG. 8 is a flow chart illustrating an operation of a control unit when an operation on an object is detected; and

FIG. 9 is a flow chart illustrating an operation of a control unit when an operation on an object is detected.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the mobile electronic device; however, the present invention is not limited to mobile phones. Therefore, the present invention can be applied to any type of devices provided with a touch panel, including but not limited to personal handyphone systems (PHS), personal digital assistants (PDA), portable navigation units, personal computers (including but not limited to tablet computers, netbooks etc.), media players, portable electronic reading devices, and gaming devices.

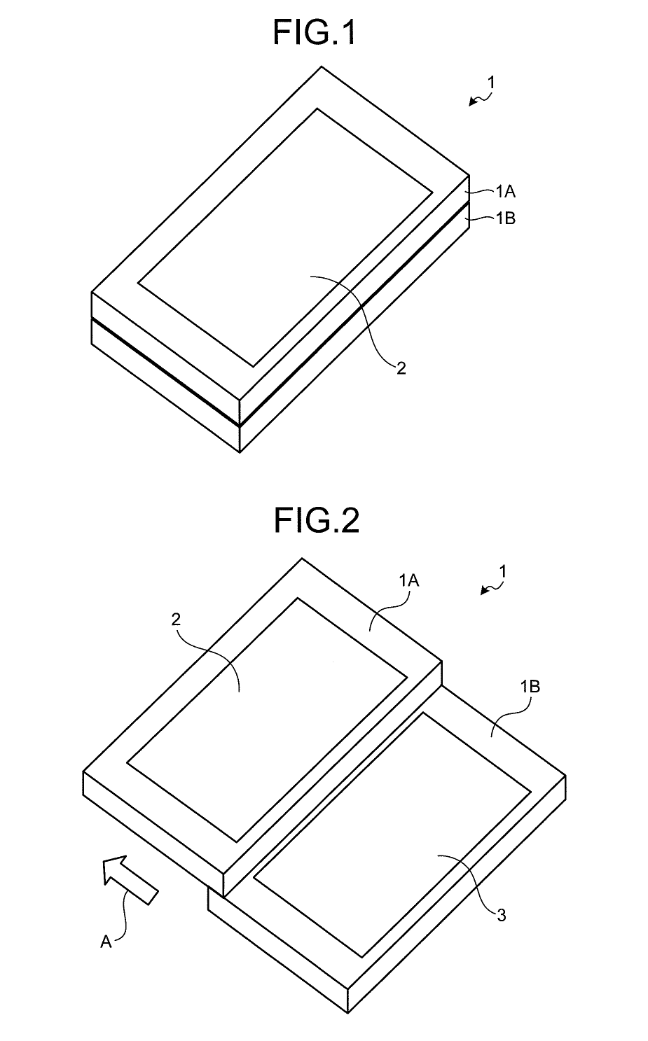

First, with reference to FIGS. 1 and 2, a description will be given of an overall configuration of a mobile phone 1 that is an embodiment of an electronic device. FIG. 1 is a perspective view of the mobile phone 1 in a first form, and FIG. 2 is a perspective view of the mobile phone 1 in a second form. The mobile phone 1 includes a first housing 1A and a second housing 1B. The first housing 1A is configured to be slidable relatively in the direction of an arrow A with respect to the second housing 1B.

The first housing 1A includes a first touch panel 2 on a side opposite to a side facing the second housing 1B. The second housing 1B includes a second touch panel 3 on a side facing the first housing 1A. The first touch panel 2 and the second touch panel 3 display characters, figures, images, and the like, and detect various operations that are performed thereon by a user with a finger, pen, or a stylus (in the description herein below, for the sake of simplicity, it is assumed that the user touches the touch panel 2 with his/her finger(s)). The second touch panel 3 is covered by the first housing 1A in the first form where the first housing 1A and the second housing 1B overlap with each other, and is exposed to the outside in the second form where the first housing 1A is slid in the direction of the arrow A.

The first form is a so-called close state. The first form is suitable for carrying the mobile phone 1 by the user, and even in the first form, the user can refer to information displayed on the first touch panel 2, and input information by operating the first touch panel 2 with a finger. The second form is a so-called an open state. The second form is suitable for using the mobile phone 1 by the user, and in the second form, the user can refer to more information by using the first touch panel 2 and the second touch panel 3.

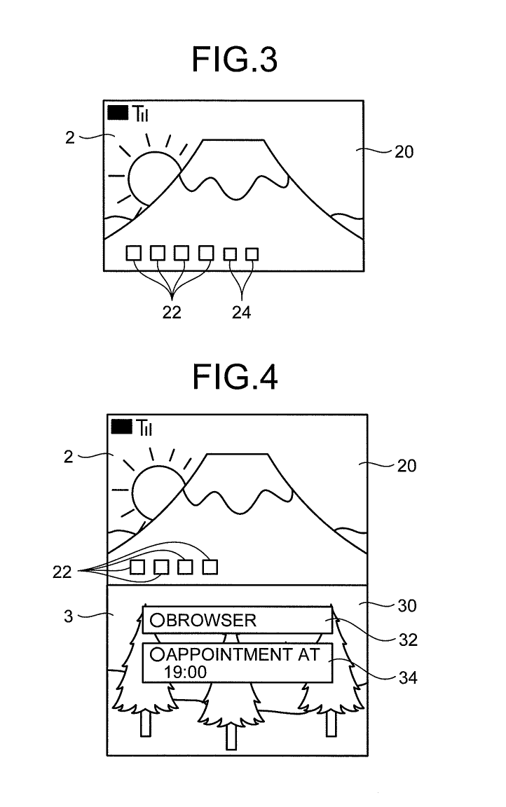

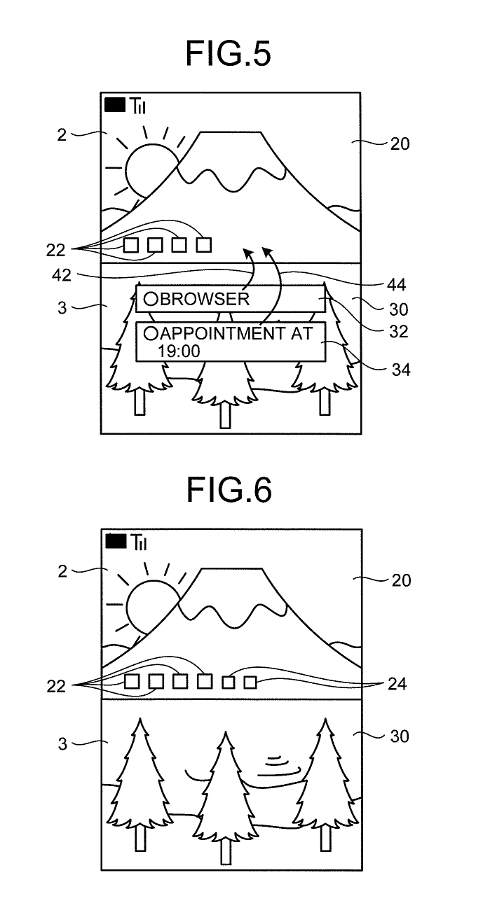

Next, with reference to FIGS. 3 to 6, a description will be given of a screen display of the mobile phone 1. FIG. 3 is a diagram illustrating an example of a screen displayed on a first display unit. FIG. 4 is a diagram illustrating an example of screens displayed on the first display unit and a second display unit. FIG. 5 is a diagram illustrating an example of screens displayed on the first display unit and the second display unit. FIG. 6 is a diagram illustrating an example of screens displayed on the first display unit and the second display unit.

The mobile phone 1 illustrated in FIG. 3 is in the first form that is the state where only the first touch panel 2 is exposed. The mobile phone 1 illustrated in FIG. 3 displays a standby screen 20 in which four objects 22 and two objects 24 are arranged on the first touch panel 2. The four objects 22 and the two objects 24 are displayed as icons. Also, the four objects 22 and the two objects 24 are arranged in a line at the lower left of the standby screen 20. The objects are associated with shortcut information about various functions and text data (string information). Examples of the objects include an object used to activate a WEB browsing function, an object used to activate an e-mail function, an object used to activate a schedule function, an object used to activate a notepad function, and an object mapped with only text information. The objects 22 and the objects 24 illustrated in FIG. 3 are displayed as identification symbols including pictograms and the like as object.

The standby screen is a screen displayed in the state of waiting for an incoming or outgoing telephone call, or in the state of waiting for an activation of any application program. In other words, the standby screen is a screen displayed before one of various function screens provided by the mobile phone 1 is displayed. The standby screen is also referred to as, for example, an initial screen, a desktop screen, a home screen, or a wallpaper screen. In the example illustrated in FIG. 3, an image of a mountain is illustrated as the standby screen; however any data may be displayed as the standby image, such as a blank screen, various image data, and animation data. Moreover, a dynamically changing image such as a calendar image or a clock image may be included as a portion of the standby screen.

Herein, the user performs an operation of shifting the mobile phone 1 from the first form to the second form by sliding the first housing 1A and the second housing 1B of the mobile phone 1 illustrated in FIG. 3. That is, the user performs a slide-open operation.

When the mobile phone 1 is transformed from the first form to the second form in the state of displaying the standby screen 20 as illustrated in FIG. 3, both the first touch panel 2 and the second touch panel 3 are exposed as illustrated in FIG. 4. At this time, the mobile phone 1 displays the standby screen 20 in which four objects 22 are arranged, that is, the standby screen 20 in which two objects 24 are not arranged, on the first touch panel 2, and displays a standby screen 30 in which an object 32 and an object 34 are arranged, on the second touch panel 3 that is newly exposed. Each of the object 32 and the object 34 is displayed as a combination of an icon and text information mapped thereto. Specifically, the object 32 is used to activate a WEB browsing function, and includes “BROWSER” is displayed as the text information. The object 34 is mapped with text information, and includes “APPOINTMENT AT 19:00” as the text information. The object 32 and the object 34 correspond to the two objects 24 illustrated in FIG. 3.

In this manner, when transformed from the first form to the second form, the mobile phone 1 changes the display area of the preset objects (the objects 24 in this embodiment) among the objects displayed in the first touch panel 2, from the first touch panel 2 to the second touch panel 3. In addition, the mobile phone 1 converts the objects whose display area is changed into the second touch panel 3, from an icon-only display mode to an icon-plus-text information display mode.

When an operation of transforming the mobile phone 1 from the second form illustrated in FIG. 4 to the first form, that is, a slide-close operation is performed, the mobile phone 1 displays the standby screen 20 in which four objects 22 and two objects 24 are arranged, on the first touch panel 2 as illustrated in FIG. 3. In this manner, whenever an operation of sliding the first housing 1A and the second housing 1B relatively is performed, the mobile phone 1 change the screen to be displayed from the screen illustrated in FIG. 3 to the screen illustrated in FIG. 4, or from the screen illustrated in FIG. 4 to the screen illustrated in FIG. 3.

In this embodiment, when an operation of transforming the mobile phone 1 from the first form to the second form is performed, the display of the objects displayed on the first touch panel and the second touch panel is changed. Accordingly, by a simple operation, the user can change the display state of the objects and recognize the details of the objects. Also, when an operation of transforming the mobile phone 1 from the second form to the first form is performed, the display of the objects displayed on the first touch panel is changed. Accordingly, by a simple operation, the user can change the display state of the objects to display the objects in a small size. Also, when an operation of transforming the mobile phone 1 from the second form to the first form is performed, the objects displayed on the covered second touch panel 3 are moved to the first touch panel 2, so that all of the created objects can be displayed in the first form.

Next, as illustrated in FIG. 5, when the mobile phone 1 is in the second form, the user performs an operation with a moving action toward the first touch panel 2 (that is, an operation in the direction indicated by an arrow 42) for the object 32, and performs an operation with a moving action toward the first touch panel 2 (that is, an operation in the direction indicated by an arrow 44) for the object 34. The operation with a moving action is, for example, a flick operation, a drag operation, or a sweep operation. A “flick operation” is an operation of touching a finger to a touch panel and then moving the finger rapidly as if flicking something. A “drag operation” is an operation of touching a finger to a touch panel, designating an object, and then designating the position of a destination of the object. A “sweep operation” is an operation of touching a finger to a touch panel and then moving the finger while keeping the finger in contact with the touch panel. The operation with a moving action is detected by the second touch panel 3 as an operation of starting a contact with a position on the second touch panel 3 and then moving the contact position while keeping the contact with the second touch panel 3.

In this manner, when the operation with a moving action is performed for the object, and another display unit different from the display unit displaying the object is present in the movement direction, the mobile phone 1 performs a process of changing the touch panel for displaying the object so that the object, for which the operation with a moving action is performed, is displayed on the touch panel present in the movement direction (the first touch panel 2 in this example). Specifically, as illustrated in FIG. 6, the standby screen 20 in which the four objects 22 and the two objects 24 are arranged is displayed on the first touch panel 2, and the standby screen 30 in which the object 32 and the object 34 are not arranged is displayed on the second touch panel 3. In this manner, the mobile phone 1 displays an object to be displayed on the first touch panel 2, as an icon-only object.

When the user performs an operation with a moving action toward the second touch panel 3 for each of the two objects 24 displayed on the first touch panel 2 as illustrated in FIG. 6, the mobile phone 1 displays the standby screen 20 in which the four objects 22 are arranged, on the first touch panel 2, and displays the standby screen 30 in which the object 32 and the object 34 are arranged, on the second touch panel 3, as illustrated in FIG. 5. In this manner, the mobile phone 1 changes the touch panel for displaying the object, also in the case where an operation with a moving action toward the second touch panel 3 for the object arranged in the first touch panel 2 is detected. In this case, the object is displayed based on the display setting of the touch panel of the destination.

As described above, when an operation with a moving action is performed for the object, the mobile phone 1 changes the display of the object based on the display setting of the touch panel (the display unit) of the destination. Accordingly, by a simple operation, the user can change the display state of the object to recognize the details of the object. Also, by a simple operation, the user can change the display state of the object to display the object in a small size.

The mobile phone 1 can use a variety of predetermined operations as an operation for converting the display of the object. An operation of performing a substantially continuous movement from one touch panel to another touch panel may be used as an operation with a moving action for an object. That is, when a contact with one touch panel and a movement of the contact are detected by one touch panel and then a contact with a region adjacent to one touch panel is detected by another touch panel, it may be determined that an operation with a moving action is detected for an object. Accordingly, the mobile phone 1 allows the user to intuitively input a process of changing the display mode of an object.

When a contact with to one touch panel and a movement of the contact are detected by one touch panel and then a contact with a region adjacent to one touch panel is not detected by another touch panel, the mobile phone 1 may determine that an operation other than a predetermined operation is input, and may perform a process as an operation which is input only to one touch panel. In this manner, when an operation over two touch panels is not input, it is determined as another operation, so that a variety of suitable operations can be input.

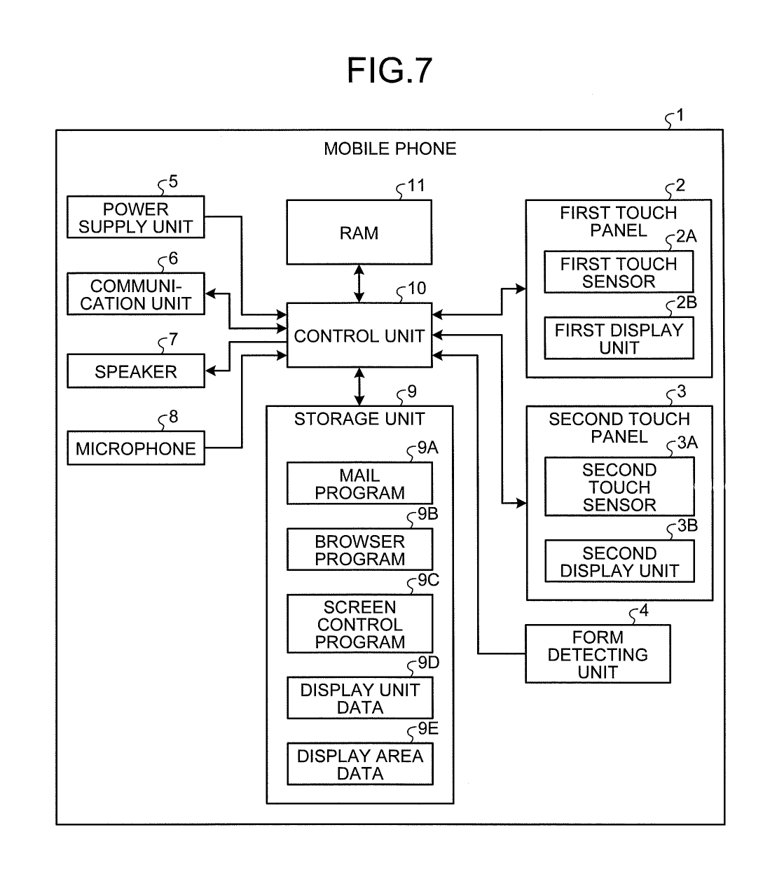

Next, a functional configuration of the mobile phone 1 will be described with reference to FIG. 7. FIG. 7 is a block diagram of the mobile phone 1. As illustrated in FIG. 7, the mobile phone 1 includes the first touch panel 2, the second touch panel 3, an form detecting unit 4, a power supply unit 5, a communication unit 6, a speaker 7, a microphone 8, a storage unit 9, a control unit 10, and a RAM (random access memory) 11. The first touch panel 2 is provided in the first housing 1A, the second touch panel 3 is provided in the second housing 1B, and the other units may be provided in any one of the first housing 1A and the second housing 1B.

The first touch panel 2 includes a first display unit 2B and a first touch sensor 2A superimposed on the first display unit 2B. The second touch panel 3 includes a second display unit 3B and a second touch sensor 3A superimposed on the second display unit 3B. The first touch sensor 2A and the second touch sensor 3A detect various operations performed on the surfaces with finger(s), as well as the positions of the operations. The operations detected by the first touch sensor 2A and the second touch sensor 3A include a tap operation, a flick operation, a drag operation, and the like. The first display unit 2B and the second display unit 3B include, for example, a LCD (liquid crystal display) or an OELD (organic electro-luminescence display), and display characters, figures, images, and the like.

The form detecting unit 4 detects whether the mobile phone 1 is in the first form or in the second form. The form detecting unit 4 detects the form of the mobile phone 1, for example, by a mechanical switch provided on the surface where the first housing 1A and the second housing 1B face each other, a sensor, etc.

The power supply unit 5 supplies power, which is obtainable from a battery or an external power supply, to the functional units of the mobile phone 1, including the control unit 10. The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a voice of the counterpart of telephone communication, a ring tone, and the like. The microphone 8 converts a voice of a user into an electrical signal.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores data and a program used in a process of the control unit 10. Specifically, the storage unit 9 stores a mail program 9A configured to implement an e-mail function, a browser program 9B configured to implement a WEB browsing function, a screen control program 9C configured to implement a screen control as described above, display unit data 9D containing information about the size and positional relation of the first display unit 2B and the second display unit 3B and information about the display setting of an object, and display area data 9E containing information about a display area for displaying an object. In addition, the storage unit 9 stores other programs and data such as an operating system (OS) program configured to implement the basic functions of the mobile phone 1, and address book data containing e-mail addresses, names, phone numbers, and the like.

The control unit 10 is, for example, a CPU (central processing unit), and integrally controls the operations of the mobile phone 1. Specifically, by referring to the data stored in the storage unit 9 as necessary, the control unit 10 executes the programs stored in the storage unit 9 and controls the first touch panel 2 and the communication unit 6 to execute various processes. If necessary, the control unit 10 loads the program stored in the storage unit 9 and data that are obtained/generated/processed by executing the process to the RAM 11 that provide a temporary storage region, as necessary. The program executed by the control unit 10 and the data referred to by the control unit 10 may be downloaded from a server through wireless communication by the communication unit 6.

For example, the control unit 10 executes the mail program 9A to implement an e-mail function. The control unit 10 executes the screen control program 9C to implement a function of displaying a screen on a display unit designated by the user as described above.

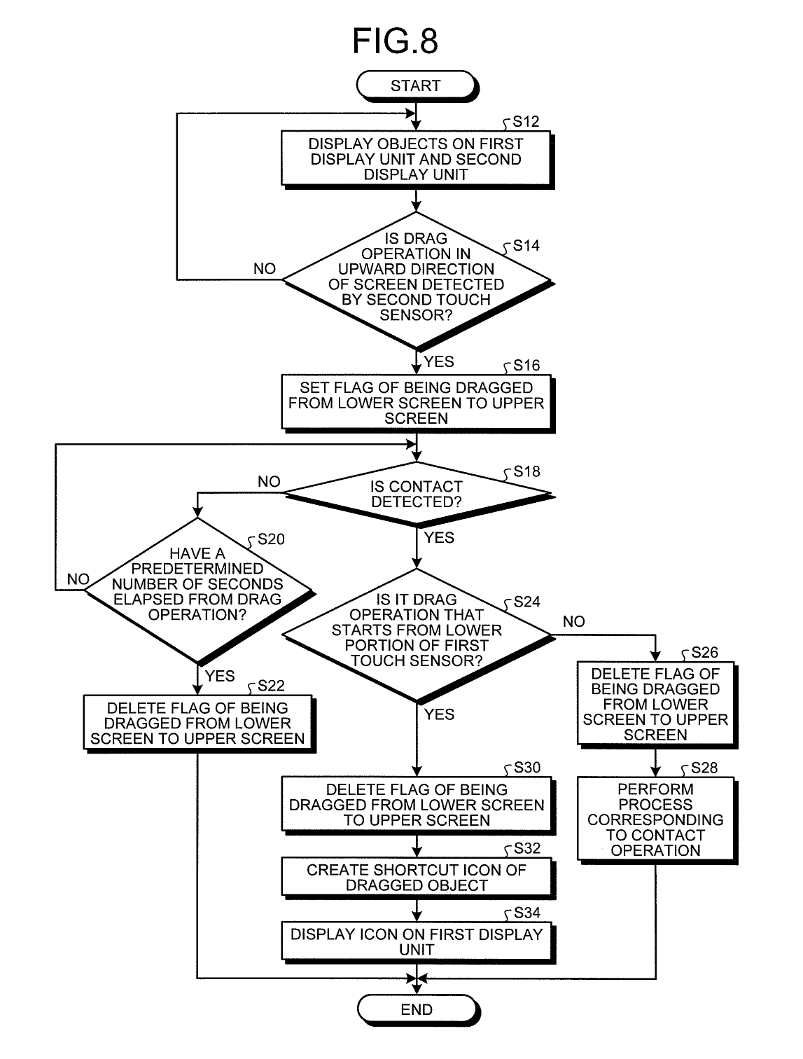

Next, a process executed by the control unit 10 on the basis of the screen control program 9C will be described with reference to FIG. 8. The process illustrated in FIG. 8 is executed when the mobile phone 1 is in the second form and displays the standby screen. FIG. 8 is a flow chart illustrating an operation of the control unit when an operation for an object is detected. The process illustrated in FIG. 8 is executed when a contact operation for the object displayed in the second touch panel 3 is input.

As illustrated in FIG. 8, the control unit 10 displays objects on the first display unit 2B of the first touch panel 2 and the second display unit 3B of the second touch panel 3, at Step S12. When the objects are displayed at Step S12, the control unit 10 determines, at Step S14, whether a drag operation in the upward direction of a screen is detected by the second touch sensor 3A. Specifically, at Step S14, the control unit 10 determines whether an operation of dragging at least one of the objects displayed on the second touch panel 3 in the upward direction of the screen is detected by the second touch sensor 3A. Although a drag operation is detected in FIG. 8, a sweep operation may also be detected in the same manner.

If a drag operation is not detected (No at Step S14), the control unit 10 returns to step S12. If a drag operation is detected (Yes at Step S14), the control unit 10 proceeds to step S16. At Step S16, the control unit 10 sets a flag of being dragged from the lower screen to the upper screen. At Step S18, the control unit 10 determines whether a contact (contact operation) is detected. That is, at Step S18, the control unit 10 determines whether an operation different from the operation detected at Step S14 is detected.

If a contact is not detected (No at Step S18), the control unit 10 proceeds to step S20. At Step S20, the control unit 10 determines whether a predetermined number of seconds have elapsed from the drag operation. The control unit 10 may measure a time from the drag operation input by a timer function and compare the measured time with a threshold time (a predetermined number of seconds) to determine whether a predetermined number of seconds have elapsed from the drag operation. If a predetermined number of seconds have not elapsed from the drag operation (No at Step S20), the control unit 10 returns to step S18.

If a predetermined number of seconds have elapsed from the drag operation (Yes at Step S20), the control unit 10 proceeds to step S22. At Step S22, the control unit 10 deletes the flag of being dragged from the lower screen to the upper screen. Thereafter, the control unit 10 ends the process. That is, the control unit 10 ends the process by determining that an object moving operation is not input.

If a contact is detected (Yes at Step S18), the control unit 10 proceeds to step S24. At Step S24, the control unit 10 determines whether the detected contact is a drag operation that starts from a lower portion (a region adjacent to the second touch panel 3) of the first touch sensor 2A. That is, the control unit 10 determines whether the detected contact is a substantially continuous operation with the drag operation detected at Step S14. If the detected contact is not the drag operation (No at Step S24), the control unit 10 proceeds to step S26. At Step S26, the control unit 10 deletes a flag of being dragged from the lower screen to the upper screen. At Step S28, the control unit 10 performs a contact processing. That is, the control unit 10 determines that the detected contact is not a substantially continuous operation with the drag operation detected at Step S14, and executes a process corresponding to the detected contact. After completion of the contact processing, the control unit 10 ends the process.

If the detected contact is the drag operation (Yes at Step S24), the control unit 10 proceeds to step S30. At Step S30, the control unit 10 deletes a flag of being dragged from the lower screen to the upper screen. At Step S32, the control unit 10 creates a shortcut icon of the dragged object. That is, the control unit 10 creates an icon corresponding to the object dragged at Step S14. After completion of the creation of the icon, at Step S34, the control unit 10 displays the icon on the first display unit 2B of the first touch panel 2. That is, the control unit 10 displays an icon corresponding to the object created at Step S32, on the first display unit 2B of the first touch panel 2 that is the touch panel of a destination. Accordingly, the display position and the display state of the object that is an operation target can be changed. After completion of the display of the icon on the first display unit 2B, the control unit 10 ends the process.

As described above, in this embodiment, when an operation with a moving action is performed for an object, the display unit for displaying the object is changed according to the movement direction; therefore, the display state of the object can be changed and the details of the object can be recognized by a simple operation. Moreover, by a simple operation, the user can change the display state of the object so as to be displayed in a small size.

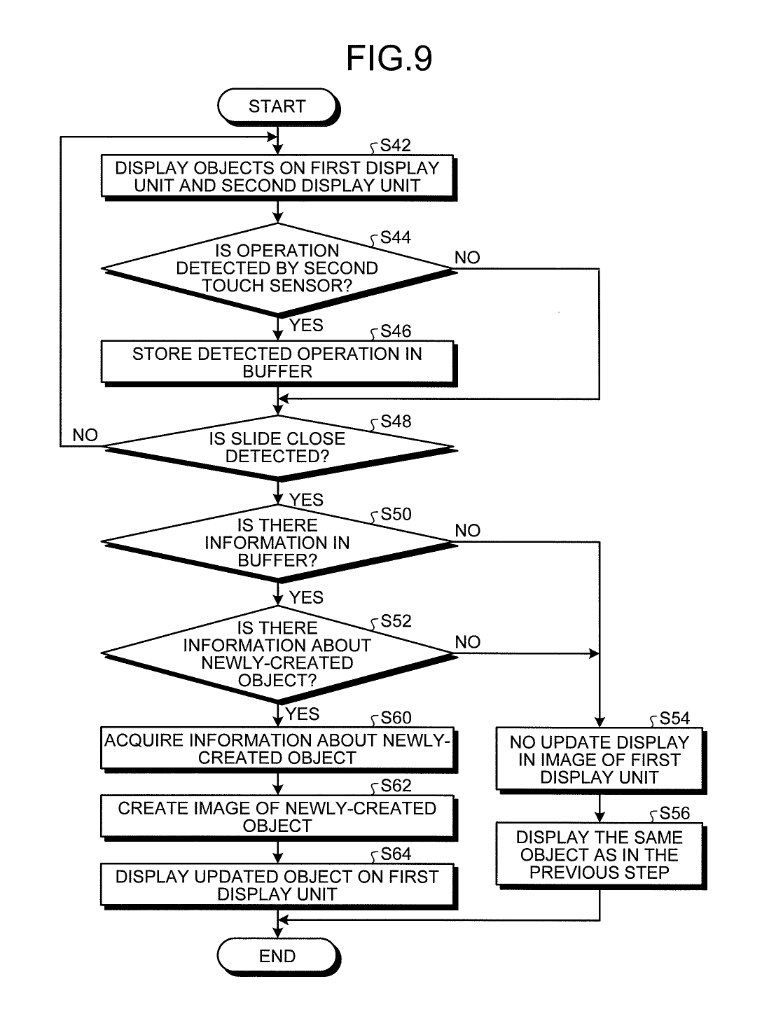

Next, another process executed by the control unit 10 based on the screen control program 9C will be described with reference to FIG. 9. The process illustrated in FIG. 9 is executed when the mobile phone 1 is in the second form. FIG. 9 is a flow chart illustrating an operation of the control unit when an operation on an object is detected. The process illustrated in FIG. 9 is executed when an operation of transforming the mobile phone 1 from the second form to the first form is performed.

As illustrated in FIG. 9, the control unit 10 displays objects on the first display unit 2B of the first touch panel 2 and the second display unit 3B of the second touch panel 3, at Step S42. When the objects are displayed at Step S42, the control unit 10 determines, at Step S44, whether an operation is detected by the second touch sensor 3A.

If a touch operation is not detected (No at Step S44), the control unit 10 proceeds to step S48. If a touch operation is detected (Yes at Step S44), the control unit 10 proceeds to step S46. At Step S46, the control unit 10 stores the detected operation in a buffer. The control unit 10 stores a variety of detected operations in the buffer, and executes a process corresponding to the detected operation.

If performing the process of step S46 or determining No at Step S44, the control unit 10 proceeds to step S48. At Step S48, the control unit 10 determines whether a slide-close operation, that is, an operation of moving the first housing 1A and the second housing 1B relatively to transform the mobile phone 1 from the second form to the first form is input. If a slide-close operation is not detected (No at Step S48), that is, if it is determined that the second form is maintained, the control unit 10 returns to step S42.

If a slide close operation is detected (Yes at Step S48), that is, if it is determined that the form is transformed into the first form, the control unit 10 proceeds to step S50. At Step S50, the control unit 10 determines whether there is information in a buffer. If there is no information in a buffer (No at Step S50), the control unit 10 proceeds to step S54. If it is determined that there is information in a buffer (Yes at Step S50), the control unit 10 proceeds to step S52. At Step S52, the control unit 10 determines whether there is information about a newly created object. That is, the control unit 10 determines whether an operation of newly creating an object, which was not displayed in the previous step, is included in the operation detected at Step S44. If it is determined that there is no information about the newly created object (No at Step S52), the control unit 10 proceeds to step S54. If it is determined that there is information about the newly created object (Yes at Step S52), the control unit 10 proceeds to step S60.

If determining No at Step S50 or step S52, the control unit 10 proceeds to step S54. At Step S54, the control unit 10 determines that an image of the first display unit 2B is not changed. At Step S56, the control unit 10 displays the same object(s) as in the previous step. That is, the same object(s) with the object(s) arranged in the standby screen in the first form is displayed in the first display unit 2B of the first touch panel 2. If there is object(s) displayed on the second touch panel 3, the control unit 10 displays the object(s) on the first display unit 2B of the first touch panel 2 with the display mode changed, in the same manner as in the process illustrated in FIG. 3 and FIG. 4. After completion of the display of the object(s) at Step S56, the control unit 10 ends the process.

If it is determined that there is information about the newly created object (Yes at Step S52), the control unit 10 proceeds to step S60. At Step S60, the control unit 10 acquires the information about the newly created object. At Step S62, the control unit 10 creates an image of the newly created object (specifically, an image of an icon). The process of step S60 and step S62 may be performed in advance when the operation is detected at Step S44. Upon completion of the process of step S62, the control unit 10 proceeds to step S64. At Step S64, the control unit 10 displays the object updated in the first display unit 2B of the first touch panel 2. That is, object(s) including an object newly created at Step S62 is displayed on the first display unit 2B. If a process of deleting an object has been input, the control unit 10 displays the object(s), excluding the deleted object from the object(s) displayed in the previous step, on the first display unit 2B. If there is object(s) displayed on the second touch panel 3, the control unit 10 displays the object(s) on the first display unit 2B of the first touch panel 2 with the display mode changed, in the same manner as in the process illustrated in FIG. 3 and FIG. 4. After completion of the display of the object at Step S64, the control unit 10 ends the process.

As described above, in this embodiment, when an operation of transforming the mobile phone 1 from the second form to the first form is performed, the display of the object(s) displayed on the second touch panel 3 is changed. Accordingly, by a simple operation, the user can convert the display state of the object(s) so as to be displayed in a small size.

It should be noted that the embodiments of the present invention described above may be modified without departing from the scope of the present invention. For example, the screen control program 9C may be divided into a plurality of modules, or may be integrated with another program.

In the above embodiments, the first housing 1A is slid with respect to the second housing 1B, so that the mobile phone 1 is transformed from the first form to the second form. However, the transformation from the first form to the second form may be achieved by an operation other than the slide operation. For example, the mobile phone 1 may be a foldable mobile phone including the first housing lA and the second housing 1B that are connected by a 2-axis rotary hinge. In this case, the first housing 1A and the second housing 1B are rotated relatively on the two axes of the hinge as a rotation axis to achieve the transformation. Alternatively, the mobile phone 1 may be a typical foldable mobile phone including the first housing 1A and the second housing 1B that are connected by a 1-axis rotary hinge.

In the above embodiments, an example of the electronic device including two display units is represented; however, the present invention may also be applicable to electronic devices including three or more display units. When the electronic devices including three or more display units displays a screen over the display units, the screen may be displayed over all of the display units or may be displayed over some of the display units which are selected in advance.

The mobile phone 1 may execute both the processes illustrated in FIG. 8 and FIG. 9, or may execute only one of the processes illustrated in FIG. 8 and FIG. 9.

The advantages are that one embodiment of the invention provides an electronic device, a screen control method, and a screen control program that allow the user to recognize the details of object by a simple operation.

What is claimed is:

1. An electronic device comprising:
a first display unit configured to display a first object corresponding to a first function;
a second display unit configured to display a second object corresponding to a second function;
a detecting unit configured to detect an operation; and
a control unit configured to dismiss the first object from the first display unit and display information with respect to the first object on the second display unit when the operation is detected by the detecting unit while the first object is displayed on the first display unit.

2. The electronic device according to claim 1, wherein
the detecting unit detects the operation when the electronic device is transformed from a first form in which the second display unit is hidden to a second form in which the second display unit is exposed.

3. The electronic device according to claim 2, further comprising:
a first housing provided with the first display unit; and
a second housing provided with the second display unit and movable relative to the first housing, wherein
the second display unit is configured to be covered by the first housing in the first form.

4. The electronic device according to claim 1, wherein
the detecting unit includes a contact detecting unit configured to detect a contact to the first display unit and the second display unit, and
the contact detecting unit detects a contact operation that moves from a location on the first display unit where the first object is displayed to the second display unit, as the operation.

5. The electronic device according to claim 4, wherein the contact operation is a drag operation, a flick operation, or a sweep operation.

6. The electronic device according to claim 4, wherein
the contact detecting unit detects a contact operation in which a contact is made with the location on the first display where the first object is displayed, the contact moves toward the second display unit, and then another contact is made with a portion adjacent to the first display unit on the second display unit within a predetermined time, as the operation.

7. The electronic device according to claim 1, wherein
the control unit displays an icon as the first object when the first object is displayed on the first display unit, and displays an image containing text information as the information with respect to the first object when the first object is displayed on the second display unit.

8. The electronic device according to claim 7, wherein
the text information is related to details of the first object.

9. The electronic device according to claim 7, wherein
a display area for the icon is smaller than that for the image containing the text information;

10. The electronic device according to claim 2, wherein
a control unit is configured to dismiss the information with respect to the first object form the second display unit and display the first object on the first display unit when the detecting unit detects that the electronic device is transformed from the second form to the second form while the information is displayed on the second display unit.

11. A screen control method executed by an electronic device including a first display unit, a second display unit, and a detecting unit, the screen control method comprising:
displaying an object corresponding to a function on the first display unit;
detecting an operation by the detecting unit while the object is displayed on the first display unit; and
dismissing the first object from the first display unit and displaying information with respect to the first object on the second display, upon detection of the operation.

12. A non-transitory storage medium that stores a screen control program for causing, when executed by an electronic device including a first display unit, a second display unit, and a detecting unit, the electronic device to execute:
displaying an object corresponding to a function on the first display unit;
detecting an operation by the detecting unit while the object is displayed on the first display unit; and
dismissing the first object from the first display unit and displaying information with respect to the first object on the second display, upon detection of the operation.
